(19) United States
(12) Patent Application Publication
(10) Pub. No.: US 2009/0171670 A1
(43) Pub. Date: Jul. 2, 2009

(54) Systems and methods for altering speech during cellular phone use

(75) Inventors: Robert Bailey, Cupertino, CA (US); Lawrence Heyl, Colchester, VT (US); Stephan Schell, Cupertino, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/079,779

(22) Filed: Mar. 28, 2008

Related U.S. Application Data
(60) Provisional application No. 61/009,716, filed on Dec. 31, 2007.

(51) Int. Cl. G10L 21/00

(52) U.S. Cl. 704/278; 704/E21.001

(57) ABSTRACT

The present invention includes systems and methods for altering a cellular phone user's speech so that the speech can be less bothersome to third parties in the surrounding area and so that the user has more privacy. Sound cancellation can be used to cancel, reduce, or modify the user's voice so third parties cannot hear the voice as easily or so that the user's voice cannot be understood. Furthermore, the user device can encourage the user to speak in a lower voice. The user device can accomplish this encouragement by indicating to the user their level of speech. In this manner, the user knows when he may lower his voice and yet still provide an adequate volume of speech for the cellular phone. Additionally, the user device can encourage the user to speak in a lower voice by audibly playing back the user's voice in real time.

This application claims the benefit of U.S. Provisional Application No. 61/009,716, filed Dec. 31, 2007, the disclosure of which is incorporated by reference herein in its entirety.

### FIELD OF THE INVENTION

This relates to methods and systems for altering speech during cellular phone use. More particularly, this can reduce, cancel, or modify a cellular phone user's speech as perceived by a surrounding third party. Additionally, this can encourage a cellular phone user to lower his level of speech while the cellular phone is in use.

### BACKGROUND OF THE INVENTION

Cellular phones have rapidly become an enjoyable and useful commodity utilized by a large percentage of the population. It is not uncommon to see cellular phones being used by people in a large variety of circumstances and environments. However, despite their great convenience and utility, cellular phone use can sometimes become a nuisance and a bother to third parties in the surrounding area.

Additionally, since a third party can hear the user's conversation, the user may not always have the amount of privacy which he desires. As used herein, “third parties” and “third party” refer to people in the general vicinity of the user who are able to hear the user's conversation.

For example, if someone is speaking on a cellular phone, the speaker's voice could potentially become an annoyance to anyone nearby. This is especially true if the user is speaking in a loud and boisterous manner. Additionally, if a user is in a noisy environment, the user may have the tendency to raise his or her voice in order to overcome the ambient noise. This occurs even if the raised voice is completely unnecessary and the cellular phone does not require the user to raise his or her voice in such a manner. Thus, not only is the user disturbing one or more surrounding people, but the user could potentially lower his voice and still allow the cellular phone to acquire a loud enough voice signal.

From another point of view, the user may desire to have a private and secure conversation on a cellular phone without needing to relocate to a secluded location. Thus, it is desirable to have a system which can allow a user to have a private conversation while still being situated in the audible range of third parties.

### SUMMARY OF THE INVENTION

In accordance with one embodiment of the present invention, systems and methods for altering a user's speech during cellular phone use are discussed herein. An audio communication device (sometimes referred to herein as a user device), such as a cellular phone, a personal computer equipped with iChat™, etc. can alter a user's voice so that it is less annoying and bothersome to third parties. Additionally, the user device can provide more privacy for the user. The user device can accomplish these goals through methods such as sound cancellation and/or preventative feedback.

In one embodiment, the user device can perform sound cancellation by first acquiring the user's audio signal (i.e., voice). The user device can then process the user's voice to create a secondary audio signal. The secondary signal can be created by the user device in a manner which will allow the signal to be audibly projected (e.g., played through a speaker). The secondary signal will then interfere with the user's audio signal. When the secondary signal interferes with the user's audio signal, the secondary signal may cancel, reduce, or modify the user's audio signal. This may cause third parties to hear a form of the user's voice which is inaudible, lower in volume, or unintelligible.

In one embodiment, the user device can encourage the user to speak more quietly. The user device can accomplish this by acquiring the user's voice and then audibly playing the user's voice back to the user in real time. This can cause the user to hear her own voice at a higher volume, thus encouraging the user to lower her voice.

In one embodiment, the user device can encourage the user to speak more quietly by indicating the user's level of speech to the user. Once the user is made aware of her own voice's volume, she can know when she is speaking too loudly and may then subsequently lower her voice.

While aspects have been described with respect to an embodiment, persons skilled in the art will appreciate that various embodiments can be combined and/or mixed together.

### BRIEF DESCRIPTION OF THE DRAWINGS

The above and other advantages of the present invention will be apparent upon consideration of the following detailed description, taken in conjunction with accompanying drawings, in which like reference characters refer to like parts throughout, and in which:

FIG. 1 illustrates a system that can operate in accordance with some embodiments of the present invention;

FIGS. 2-3 illustrate systems that can operate in accordance with some embodiments of the present invention and additionally illustrate the use of a shield for either mechanical dampening and/or sound cancellation;

FIG. 4 is a simplified schematic block diagram of circuitry in accordance with some embodiments of the present invention;

FIG. 5 is a schematic view of a communications system in accordance with one embodiment of the invention;

FIG. 6 is a simplified logical flow of an illustrative mode of operation in accordance with some embodiments of the present invention;

FIG. 7 is a simplified logical flow of illustrative modes of sound cancellation in accordance with some embodiments of the present invention;

FIG. 8 is a simplified logical flow of illustrative modes of formant cancellation in accordance with some embodiments of the present invention;

FIGS. 9-10 are simplified logical flows of illustrative modes of preventative feedback in accordance with some embodiments of the present invention; and

FIGS. 11-12 display components that can be presented in accordance with some embodiments of the present invention.

### DETAILED DESCRIPTION OF THE INVENTION

Current communication systems allow users to employ electronic devices, sometimes referred to herein as “user devices”, to communicate with second parties. As used in this text, “second parties” refer to persons using electronic devices with whom the user is communicating or to systems with whom the user is communicating. For example, the user can be communicating with a friend using a friendly device, such as another cellular phone. As another example, the user can be communicating with a system, such as a voicemail system. However, should a third party be present and be capable of hearing the user's speech, not only has the user sacrificed privacy, but the user's voice can also be an annoyance to the third party.

The present invention relates to systems and methods for altering speech during cellular phone use. Altering speech can allow the user to have additional privacy when making a phone call in public and/or may prevent the user's voice from becoming an annoyance to nearby people. The present invention is directed to achieving these goals. One method of achieving these goals is to utilize a user device which can alter the user's voice. The user device can adjust the user's audio signal (voice) in a manner which reduces, cancels, or modifies the user's voice. Therefore, third parties may only hear speech from the user that is reduced, cancelled, or modified in form and thus may be less bothersome to nearby people. Alternatively, a system of preventative feedback can be utilized. In this embodiment, the user device can process the user's voice in a manner to encourage the user to speak at a lower level. Each of these techniques, as well as corresponding examples, is discussed in greater detail below.

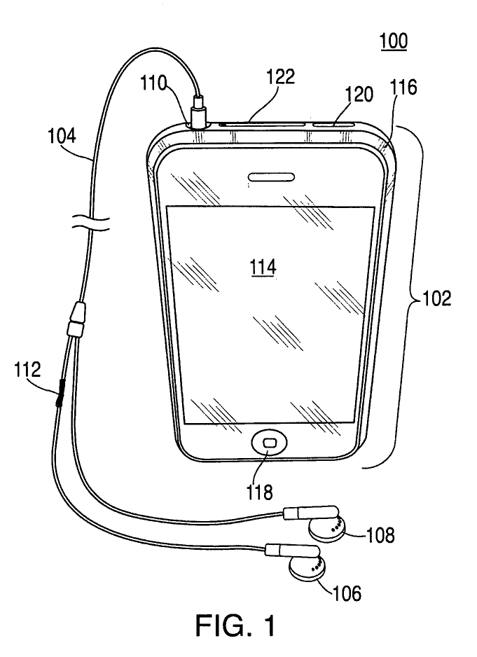

FIG. 1 shows system 100. System 100 can consist of, for example, a cellular phone which communicates over a cellular network to reach the second party. Additionally, system 100 can be a cellular phone that communicates through non-cellular network means, such as Voice Over Internet Protocol (VoIP). As another embodiment, system 100 can be any system for audibly communicating over the Internet, such as iChat™ (trademark owned by Apple Inc.). System 100 can include, but is not limited to, any of the embodiments mentioned herein.

In some embodiments, system 100 can consist of media device 102 and one or more accessory devices 104. Media device 102 can be both the user device and a friendly device being used by a person with whom the user is communicating. Generally, any of the components of system 100 described below can be integrated into media device 102 and/or contained in accessory device 104.

Referring again to FIG. 1, a possible embodiment and possible components for system 100 are illustrated. In some embodiments, accessory device 104 can include right and left earphones 106 and 108 which can be attached to media device 102 through headset jack 110. Alternatively, accessory device 104 can consist of only one of either earphone 106 or earphone 108. Additionally, although earphones 106 and 108 are illustrated as being integrated into accessory device 104, earphones 106 and 108 can also be integrated into media device 102, for example, as one or more speakers. Alternatively, earphones 106 and 108 can be a wireless device.

Microphone 112 is illustrated in FIG. 1 as being integrated into the same accessory device 104 as earphones 106 and 108. However, microphone 112 can alternatively be contained in a different accessory device that is separate from earphones 106 and 108. In another embodiment, microphone 112 can be integrated into media device 102 or can be a wireless device. In general, persons skilled in the art will appreciate that the various components discussed herein can exist as a component of media device 102, as a component of accessory device 104, or as a wireless device.

System 100, as illustrated, additionally can include display screen 114. Further to the discussion above, display screen 114 does not need to be integrated into media device 102, and in other embodiments can be an accessory to or wirelessly in communication with media device 102. For example, display screen 114 can be a television screen, a computer monitor, a graphical user interface, a textual user interface, a projection screen, or any combination thereof. Display screen 114 can present various types of information to the user such as graphical and/or textual displays. This can include, for example, menu options, incoming/outgoing phone call information, stored videos, stored photos, stored data, system information, etc. Additionally, display screen 114 can also function as a user input component that allows for a touch screen, user input via a stylus, etc.

System 100 can also include outer protective casing 116 and any combination of user input components, such as user input component 118 and user input component 120. User input components 118 and 120 can be, for example, buttons, switches, track wheels, click wheels, etc. Additionally, there can be multiple ways of connecting accessories devices through components such as, for example, headset jack 110. Persons skilled in the art will appreciate that, in addition to headset jack 110, one or more alternative connectors such as USB ports, 30-pin connector ports, dock or expansion ports, etc. could also be included in media device 102.

System 100 can also have slot 122 for introducing external data and/or hard drives into system 100. For example, slot 122 can enable media device 102 to receive SIM cards, flash drives, external hard drives, etc. Although only a single slot 122 is illustrated in FIG. 1, in other embodiments system 100 could contain one or more instances of slot 122.

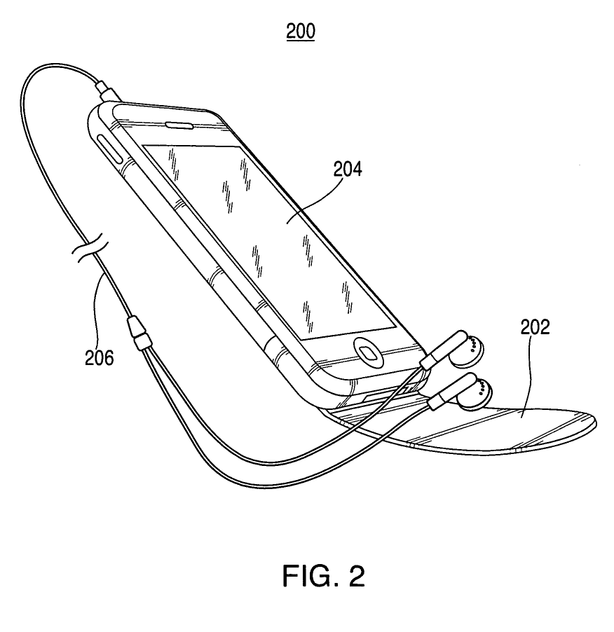

FIG. 2 shows system 200. System 200 can include any or all of the components of and functions similar to system 100. When a user is operating system 200, shield 202 can be used to alter the user's voice. Shield 202 can alter the user's audio signal (voice) in a manner which reduces, cancels, or modifies the audio signal. In response to shield 202 altering the audio signal, third parties may hear a reduced, cancelled, or modified form of the user's voice. Although system 200 illustrates shield 202 as being physically coupled to media device 204, shield 202 can have other embodiments. For example, shield 202 can fold against or slide into media device 204. In another embodiment, shield 202 can be integrated into accessory device 206 or can be a wireless device. Alternatively, shield 202 can be located inside media device 204.

Shield 202 can alter the user's voice by mechanically dampening the sound or by performing sound cancellation on the audio signal. Alternatively, shield 202 can utilize a combination of both mechanical dampening and sound cancellation. An embodiment combining both mechanical dampening and sound cancellation is useful since mechanical dampening is typically more effective against higher frequencies while sound cancellation is typically more effective against lower frequencies.

As used herein, the phrase “sound cancellation” refers to any method for altering a first sound wave by simultaneously projecting a secondary sound wave. For example, antisound projection, formant cancellation, and interference creation are all possible methods for altering a first sound wave through the projection of a secondary wave. Systems and methods for performing sound cancellation are discussed in greater detail below.

The material, physical configuration, and dimensions of shield 202 can relate to whether shield 202 performs mechanical dampening and/or sound cancellation. For example, when shield 202 functions as a mechanical dampener, then a material which effectively attenuates, absorbs, and/or reflects audio waves can be desirable. Additionally, to effectively dampen the user's speech, shield 202 can be designed to cover a significant portion of the user's mouth and physically block the user's voice. However, if shield 202 only performs sound cancellation, system 200 could potentially achieve a smaller, sleeker physical design. In this case, the main necessity governing the size and shape of shield 202 is that shield 202 and/or media device 204 contain the essential circuitry, materials, and input/output capabilities to perform sound cancellation.

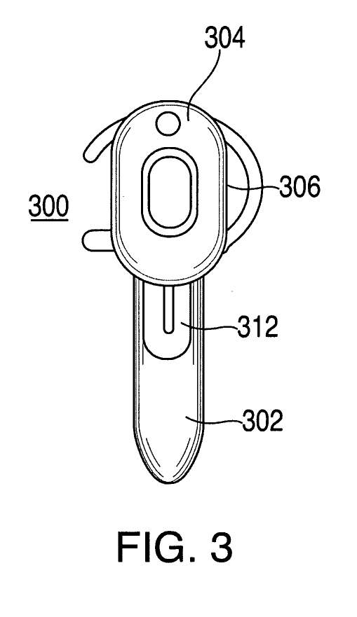

In addition to being electrically coupled to system 200, whether as part of media device 204 or as part of accessory device 206, FIG. 3 illustrates that shield 202 can also be electrically coupled to wireless system 300. Wireless system 300 can contain wireless device 304 and shield 302. Wireless device 304 can include, for example, speaker 306 and boom/microphone 312. Although FIG. 3 illustrates wireless device 304 as a wireless headset, persons skilled in the art will appreciate that wireless device 304 does not have to be a wireless headset. Rather, wireless device 304 can be any suitable wireless accessory for use in cellular phone technology. Additionally, similar to system 200 and shield 202, shield 302 is not limited to being physically coupled to wireless device 304. For example, in another embodiment shield 302 can fold against or slide into wireless device 304. Alternatively, shield 302 can be integrated into or be an accessory to wireless device 304. For example, if wireless device 304 is a wireless headset, then shield 302 may be integrated into the boom/microphone 312 of the wireless headset.

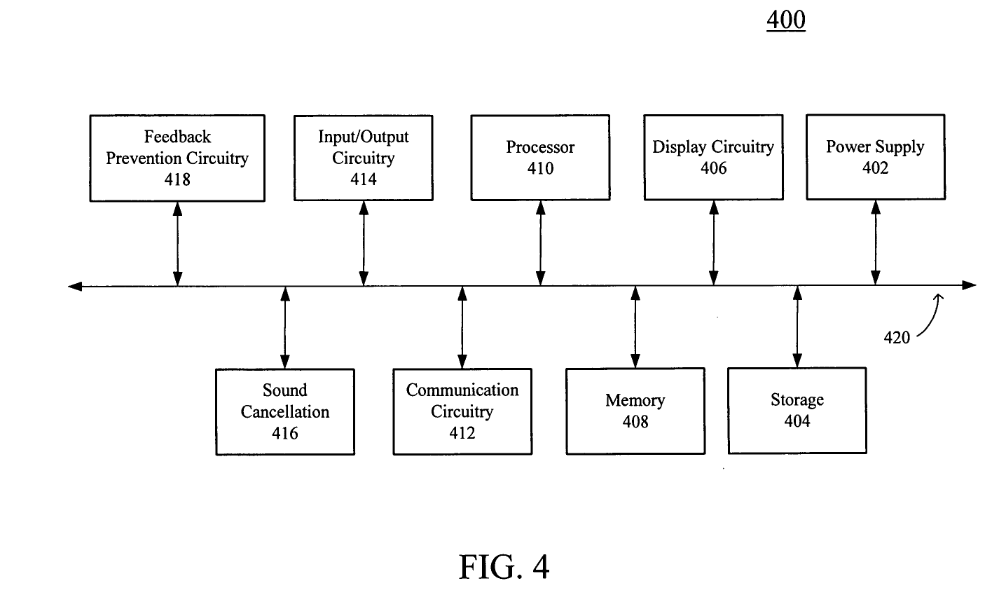

FIG. 4 illustrates a simplified schematic diagram of an illustrative electronic device or devices in accordance with one or more embodiments of the present invention. System 100, system 200, and wireless system 300 are examples of systems that can include some or all of the circuitry illustrated by the electronic device of FIG. 4.

Electronic device 400 can include, for example, power supply 402, storage 404, display circuitry 406, memory 408, processor 410, communication circuitry 412, input/output circuitry 414, sound cancellation circuitry 416, and/or preventative feedback circuitry 418, all of which can be coupled together via bus 420. In some embodiments, electronic device 400 can include more than one instance of each component of circuitry, but for the sake of simplicity and clarity, only one of each instance is shown in FIG. 4. In addition, persons skilled in the art will appreciate that the functionality of certain components can be combined or omitted and that additional or less components, which are not shown in FIGS. 1-4, can be included in, for example, systems 100, 200, 300 or 400.

Power supply 402 can provide power to the components of device 400. In some embodiments, power supply 402 can be coupled to a power grid such as, for example, a wall outlet or automobile cigarette lighter. In some embodiments, power supply 402 can include one or more batteries for providing power to an electronic device. As another example, power supply 402 can be configured to generate power in an electronic device from a natural source (e.g., solar power using solar cells).

Storage 404 can be, for example, a hard-drive, flash memory, cache, ROM, and/or RAM. Additionally, storage 404 can be local to and/or remote from electronic device 400. For example, storage 404 can be integrated storage medium, removable storage medium, storage space on a remote server, wireless storage medium, or any combination thereof. Furthermore, storage 404 can store data such as, for example, system data, user profile data, and any other relevant data.

Display circuitry 406 can accept and/or generate commands for displaying visual information to the user on a display device or component, such as, for example, display 114 of FIG. 1. Additionally, display circuitry 406 can include a coder/decoder (CODEC) to convert digital media data into analog signals and vice versa. Display circuitry 406 also can include display driver circuitry and/or circuitry for operating display driver(s). The display signals can be generated by processor 410 or display circuitry 406. The display signals can provide media information related to media data received from communications circuitry 412 and/or any other component of electronic device 400. In some embodiments, display circuitry 406, like any other component discussed herein, can be integrated into and/or electrically coupled to electronic device 400.

Memory 408 can include any form of temporary memory such as RAM, buffers, and/or cache. Memory 408 can also be used for storing data used to operate electronic device applications.

Processor 410 can be capable of interpreting system instructions and processing data. For example, processor 410 can be capable of executing programs such as system applications, firmware applications, and/or any other application. Additionally, processor 410 has the capability to execute instructions in order to communicate with any or all of the components of electronic device 400.

Communication circuitry 412 can be any suitable communications circuitry operative to initiate a communications request, connect to a communications network, and/or to transmit communications data to one or more servers or devices within the communications network. For example, communications circuitry 412 can support one or more of WiFi (e.g., a 802.11 protocol), Bluetooth (trademark owned by Bluetooth Sig, Inc.), high frequency systems, infrared, GSM, GSM plus EDGE, CDMA, other cellular protocols, VoIP, FTP, P2P, SSH, or any other communication protocol and/or any combination thereof.

Input/output circuitry 414 can convert (and encode/decode, if necessary) analog signals and other signals (e.g., physical contact inputs, physical movements, analog audio signals, etc.) into digital data. Input/output circuitry 414 can also convert digital data into any other type of signal. The digital data can be provided to and received from processor 410, storage 404, memory 408, or any other component of electronic device 400. Although input/output circuitry 414 is illustrated in FIG. 4 as a single component of electronic device 400, a plurality of input/output circuitry components can be included in electronic device 400. Input/output circuitry 414 can be used to interface with any input or output component, such as those discussed in connection with FIGS. 1-3. For example, electronic device 400 can include specialized input circuitry associated with input devices such as, for example, one or more microphones, cameras, proximity sensors, accelerometers, ambient light detectors, etc. Electronic device 400 can also include specialized output circuitry associated with output devices such as, for example, one or more speakers, earphones, LED's, LCD's, etc.

Sound cancellation component 416 can include any circuitry that enables electronic device 400 to alter an audio signal. For example, electronic device 400 can acquire an audio signal from the user when the user speaks into electronic device 400. Sound cancellation component 416 can then reduce, cancel, or modify the audio signal. As a result of the audio signal alteration, third parties may perceive the audio signal to be reduced, cancelled, or modified in form. Audio signal alteration can be achieved through various methods such as, for example, antisound projection, formant cancellation, and/or interference. More in-depth illustrations of these methods are provided in the descriptions to follow. Sound cancellation component 416 can utilize any or all of the other components of electronic device 400 and/or any other device coupled to electronic device 400. In some embodiments, software can also be used to perform some or all of sound cancellation component 416's functions.

Preventative feedback circuitry 418 can enable electronic device 400 to encourage the user to speak at a lower level. For example, preventative feedback circuitry 418 can acquire an audio signal from the user when the user speaks into electronic device 400. Preventative feedback circuitry 418 can then output the same audio signal at an intensity level (volume) relative to the user's voice level. The user could hear his own speech being played by the user device in real time and potentially perceive himself to be speaking louder than he actually is speaking. This can consciously or subconsciously cause the user to lower his own voice. Preventative feedback circuitry 418 can utilize any or all of the other components of electronic device 400 and/or any other device coupled to electronic device 400. In some embodiments, software can also be used to perform some or all of preventative feedback circuitry 418's functions. More embodiments of preventative feedback and more detailed illustrations are provided below.

Bus 420 can provide a data transfer path for transferring data to, from, or between any of processor 410, storage 404, memory 408, communications circuitry 412, and any other component included in electronic device 400. Although bus 420 is illustrated as a single component in FIG. 4, persons skilled in the art will appreciate that electronic device 400 may include one or more instances of bus 420, depending on which devices were coupled together.

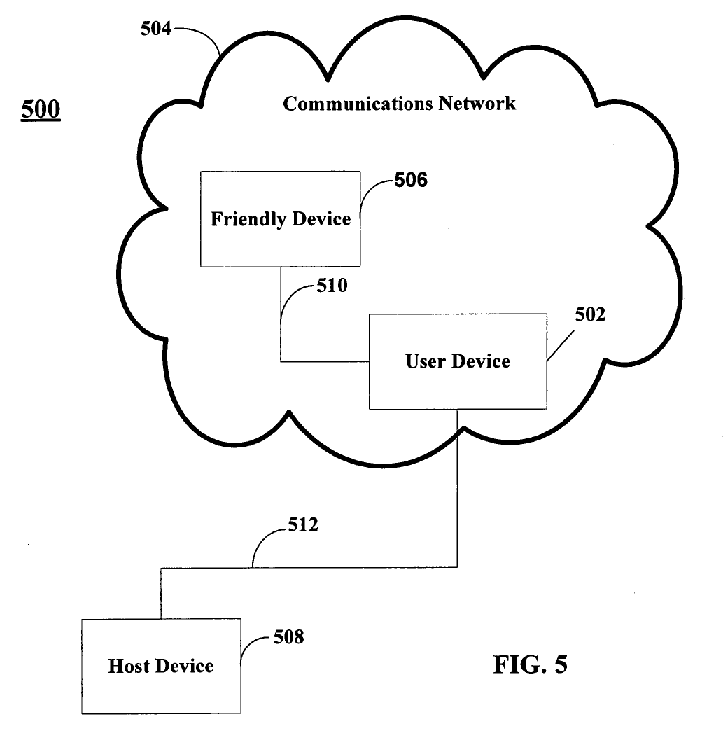

FIG. 5 is a schematic view of communications system 500 in accordance with one embodiment of the invention. Communications system 500 can include user device 502 coupled to communications network 504. User device 502 can use communications network 504 to perform wireless communications with other devices within communications network 504 such as, for example, friendly device 506. Although communications system 500 can include several user devices 502, friendly devices 506, and host devices 508, only one of each is shown in FIG. 5 for simplicity and clarity.

Any suitable circuitry, device, system, or combination of these components operative to create a communications network can be used to create communications network 504. For example, communication network 504 can be a wireless communications infrastructure including communications towers and telecommunications servers. Communications network 504 can be capable of providing wireless communications using any suitable short-range or long-range communications protocol. In some embodiments, communications network 504 can support, for example, Wi-Fi, Bluetooth™, high frequency systems, infrared, VoIP, or any combination thereof. In some embodiments, communications network 504 can support protocols such as, for example, GSM, GSM plus EDGE, CDMA, quadband, and other cellular protocols. User device 502 and friendly device 506, when located within communications network 504, can wirelessly communicate over a local wireless communication path such as path 510.

User device 502 and friendly device 506 can be any suitable device for sending and receiving audible communications. For example, user device 502 and friendly device 506 can include a cellular telephone such as an iPhone (available from Apple Inc.), pocket-sized personal computers such as an iPAQ Pocket PC (available from Hewlett Packard Inc.), personal digital assistants (PDAs), a personal computer utilizing a chat program such as iChat™, and any other device capable of audibly communicating.

User device 502 can be coupled with host device 508 over communications link 512 using any suitable approach. For example, user device 502 can use any suitable wireless communications protocol to connect to host device 508 over communications link 512. As another example, communications link 512 can be a wired link that is coupled to both user device 502 and host device 508. As still another example, communications link 512 can include a combination of wired and wireless links.

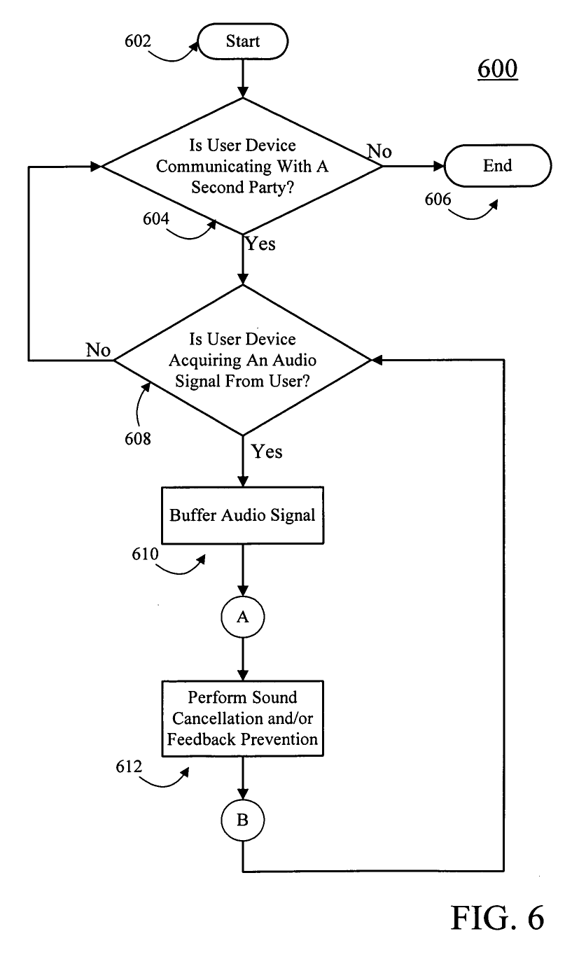

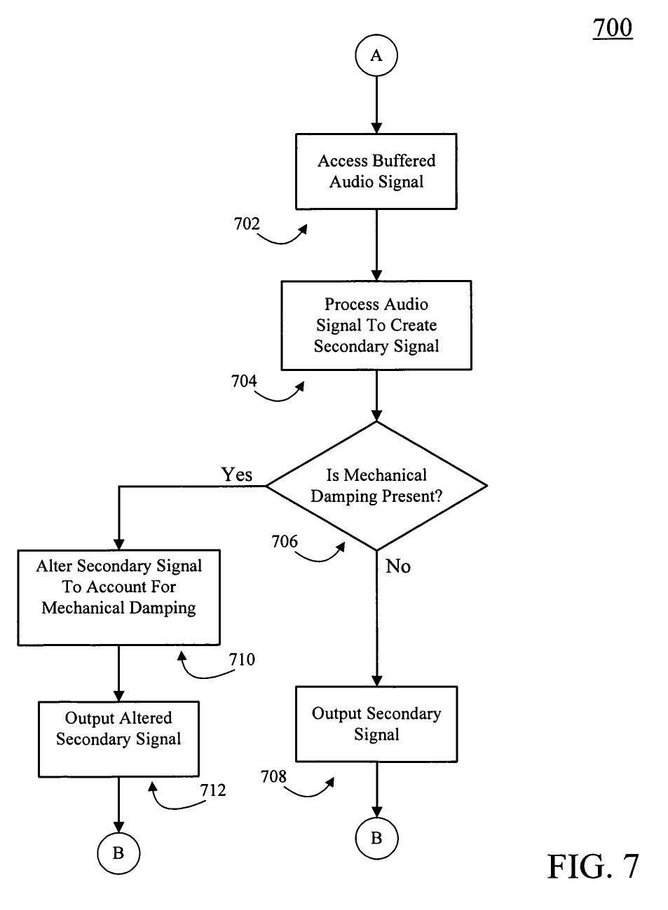

As mentioned above, the present invention relates to systems and methods for altering speech during cellular phone use. This is performed to provide additional privacy for the user and/or to prevent the user's voice from becoming an annoyance to nearby people in the general vicinity. FIG. 6 is an illustrative flowchart of process 600 that can be used to alter speech and achieve the above-mentioned goals. Process 600 accomplishes these goals through sound cancellation and/or preventative feedback, both of which are described in greater detail with respect to FIGS. 7-11 and in the descriptions below.

Process 600 begins at step 602. After step 602, step 604 determines if the user device is facilitating audio communications with a second party. As described earlier, the second party can include, for example, a friend using another phone, a system such as a voicemail account, or any person or system with whom the user may desire to communicate. To “facilitate audio communications” with a second party, the user device can, for example, initiate a communications request (i.e., being placing a call to another phone, etc.), connect to a communications network, and/or transmit communications data. If the user device is not facilitating communications with a second party, the process ends at step 606.

In response to the user device facilitating audio communications with a second party, the process proceeds to step 608. In step 608, the user device determines if the user device is receiving an audio signal from the user. The user device can acquire an audio signal from the user when, for example, the user speaks into the phone, provides any form of audible input with the intent of communicating this audible input to the second party, etc. The user device can acquire the audio signal through devices such as, for example, a microphone, an audio sensor, etc.

In response to the user device not receiving an audio signal from the user, the process returns to step 604 and once again asks if the user device is communicating with a second party. Returning to this step can be beneficial since, in the event that communication with the second party is lost, the process may not continue to proceed indefinitely. Rather, when the user is not speaking, the process can check to see if the user device is still in communication with the second party. If this is not the case, then the process ends. This can allow the user device to refrain from wasting power such as battery power, etc.

In response to the user device receiving an audio signal from the user, step 610 then buffers the audio signal for subsequent processing. The user device can store the buffered audio signal in, for example, devices such as storage 404 and/or memory 408. Prior to storage of the audio signal, the user device can first decode, encode, digitize, or otherwise pre-process the audio signal.

In step 612, the user device processes the stored audio signal to perform sound cancellation and/or preventative feedback. These two sub-processes are described in more detail in the descriptions below and are shown in FIGS. 7-11. As illustrated in FIG. 6, step 612 begins at the “A” and ends at the “B”. As will be apparent from the figures which follow, “A” and “B” are not intended to show additional steps, even though additional steps can be added without departing from the spirit of the invention.

After completing step 612, the process returns to step 608 and can again determine if the user device is receiving an audio signal from the user. As long as the user device is receiving an audio signal from the user (i.e., as long as the user is speaking into the phone, etc.), process 600 executes steps 608-612 and the user device performs sound cancellation and/or preventative feedback. Otherwise, the process proceeds to step 604 and determines if the user device is still communicating with a second party. Once again, in step 604 if the user device is no longer communicating with a second party, the process is terminated.

The process of sound cancellation, as referenced by step 612 of FIG. 6, can be performed through several methods. These methods generally involve a way of altering the audio signal that the user device acquires from the user (i.e., altering the voice of the user as he speaks into the phone, etc.). The user device can alter the audio signal so that third parties may hear a cancelled, reduced, or modified form of the audio signal. In this manner, the user's voice may be inaudible, quieter, or unintelligible to third parties. However, it can additionally be beneficial to alter the audio signal in a manner which not only causes third parties to hear an altered audio signal, but also simultaneously allows the second party to receive the unaltered, original audio signal. In this manner, the second party can hear the audio signal clearly while third parties can hear an altered audio signal that can be less annoying and bothersome.

In an ideal case, the audio signal which third parties receive can be completely cancelled, which would prevent the third party from hearing any portion of the user's conversation. In another embodiment, the audio signal received by the third party can be reduced in intensity (lower in volume), thus increasing the difficulty a third party has in hearing and/or understanding the user's voice. In yet another embodiment, the audio signal can be audibly altered. Thus, although the third party can be capable of hearing a distorted form of the user's conversation, they may not be able to understand the meaning. This can provide privacy for the user and can also be less of an annoyance to third party members, since if a third party is incapable of understanding a conversation, they psychologically may be less inclined to pay attention to the conversation (i.e., there may be less incentive or inclination to listen when you can't understand what the other person is saying).

Any combination of the above-mentioned sound cancellation embodiments can be performed together and, as mentioned previously, sound cancellation can also be performed simultaneously with mechanical dampening. Additionally, sound cancellation typically requires the use of a device such as, for example, a speaker, to generate a secondary audio signal. The secondary signal can be generated simultaneously with the user's audio signal (voice) and the two signals interfere with each other. The signal interference creates an altered audio signal which the third party can hear. However, it can additionally be beneficial to provide acoustic isolation between the user device and the speaker which generates the secondary signal. Otherwise, similar to the third party, the user device can also acquire an altered audio signal. This can cause the second party to receive an undesirable audio signal from the user device which is cancelled, reduced, or modified in form. The acoustic isolation could be achieved, for example, through the use of a directional speaker and/or acoustic insulation to shield the user device, etc.

One method for accomplishing the sound cancellation process referenced by step 612 of FIG. 6 is demonstrated by FIG. 7. This involves processing the user's audio signal (i.e., the user's voice when he speaks into the phone, etc.) to simultaneously generate a secondary audio signal. The secondary audio signal can interfere with and alter the user's audio signal. For example, the user device can generate and project antisound signals. Antisound signals can be generated by creating a secondary signal which matches the user's audio signal exactly in amplitude and frequency. However, the secondary signal is 180° out of phase with the user's audio signal. Thus, when the secondary signal is generated with the user's audio signal (is played simultaneously while the user is speaking), in an ideal case the two signals would interfere with each other and exactly cancel one another. If the two signals exactly cancel one another, then the third party would be unable to hear any portion of the user's conversation. However, in a non-ideal case, there can be some residual audio signal due to signal timing and/or spatial errors, etc. Thus, the third party may hear a quieter or modified form of the user's voice. As another embodiment, the secondary signal may not be exactly the same amplitude, frequency, and 180° out of phase with the audio signal, but can be sufficiently processed so as to muffle, reduce, and/or distort the sound the third party can hear.

Process 700 can begin at Point A, which coincides with Point A shown in FIG. 6 of process 600. Since process 700 can end at Point B, which likewise coincides with Point B shown in FIG. 6 of process 600, it should be noted that the entirety of process 700 can be contained within step 612 of FIG. 6. In initial step 702 of process 700, the user device can access the stored audio signal. The user device may, for example, have acquired this audio signal from the user in step 608 and then stored this audio signal in step 610 of process 600.

After accessing the buffered audio signal in step 702, the user device can then process the audio signal to create a secondary signal in step 704. The audio signal can be processed in a manner to allow the secondary signal to be used for sound cancellation. For example, as mentioned earlier, the phase of the audio signal can be shifted by 180° to allow for antisound generation. Alternatively, the amplitude, frequency, and/or phase can be modified in a manner to allow the secondary signal to interfere with the audio signal and reduce or suitably distort the audio signal which the third party hears.

In step 706, the user device can determine if mechanical dampening is present. If no mechanical dampening is present, then the process can proceed to step 708 and output the secondary signal. The secondary signal can then interfere with the user's audio signal and, depending on the audio processing method, can cancel, reduce, and/or modify the signal.

If however, mechanical dampening is present, then alternate step 710 can be performed prior to outputting the secondary signal. This can be desirable since, if the user device is employing a system which utilizes both mechanical dampening and sound cancellation, then the mechanical dampening can independently modify or muffle the audio signal which the third party hears. Therefore, it can be beneficial for the user device to alter the secondary signal in a manner which accounts for the mechanical dampening. For example, if the antisound signal is not altered to take mechanical dampening into account, the antisound signal's intensity can be greater than the mechanically dampened audio signal's intensity (i.e., louder than the user's muffled voice). The third party could subsequently hear the antisound signal mixed with the muffled audio signal, rather than hearing the antisound signal mixed with the original audio signal. However, since the antisound's intensity would be greater than the muffled audio signal's intensity, the antisound can fail to completely cancel the muffled audio signal, thus reducing the beneficial effects of the antisound signal. This can result in a system which not only fails to cancel the audio signal, but also actually creates additional and undesirable noise for the third party.

There are several methods which can be utilized to determine if mechanical dampening is present. For example, if a mechanical dampening device is always present or not present within the system, then this information can be directly programmed into the software or the hardware of the user device. As another example, if a mechanical dampening device is removable or not always available, then the user device can utilize sensors such as, for example, mechanical switches or electrical switches for determining if the mechanical dampening device is connected to the system.

As mentioned above, the secondary signal is typically created to match the user's audio signal in amplitude and frequency, and yet be 180° out of phase with the user's audio signal. In a non-ideal case, the secondary signal may fail to completely cancel the user's voice. Additionally, depending on where a third party is located in relation to the user device, the third party may hear more or less of the user's voice, depending on how accurately the secondary signal is canceling the user's voice in that particular location. In other words, some locations may be more ideal and hear less of the user's voice than other locations. Thus, rather than outputting a secondary signal that continuously matches the user's audio signal in amplitude and is 180° out of phase, the user device could alternatively sweep the amplitude and phase of the secondary signal. This would cause the “ideal location” to continuously change. Thus, the locations exhibiting the most accurate and the least accurate sound cancellation would be changing, and a third party member would not be restricted to experiencing only the good quality or only the poor quality sound cancellation.

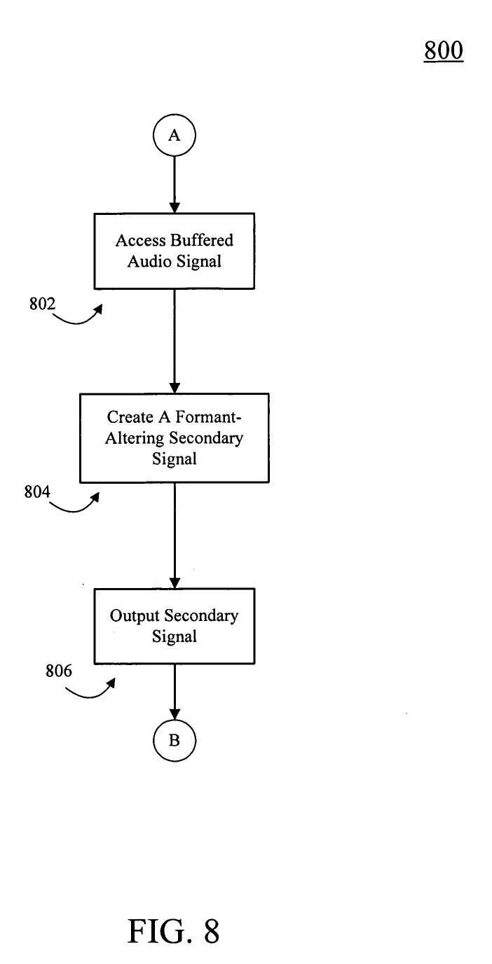

Another illustrative process of sound cancellation is demonstrated by FIG. 8. This process deals with formant cancellation. Formants can be any one or more frequency regions of relatively great intensity in a sound spectrum. Process 800 illustrates a method of creating a secondary signal which can cancel or alter one or more formants of the user's audio signal (voice). This can result in the secondary signal altering the portions of the user's voice that have the greatest intensity, thus potentially rendering the user's voice unintelligible to people in the surrounding area.

More specifically, one of the characteristics of all speech, independent of language, is that the speech signal can be modeled by exciting a cascade of bandpass filters with either a periodic signal (creating a “buzz” sound) or an aperiodic signal (creating a “hiss” sound). The formants of a speech signal are defined by their center frequencies and by the widths of the frequency spectrum which they cover. These formants give speech sounds their characteristic timbre. For example, due to formants, the vowels “a” and “e” are distinguishable even when they are spoken in the same pitch. Additionally, the characteristics of a formant tend to be invariant. Thus, when a speech signal (voice) is altered over the expected frequency range of the formant, the clarity and intelligibility of the speech signal can be significantly affected.

A preferred embodiment of formant cancellation could include a filter that produces significant loss over the formant domain, thus greatly reducing the most significant portions of a person's voice. For example, a secondary signal can be created that significantly filters a user's voice from roughly 500 to 3,000 Hertz, thus altogether suppressing the formant-shaped components of the voice. This can result in third parties hearing a significantly quieter or unintelligible form of the user's voice.

To create the specific secondary signal, the user device may store pre-existing formant data in a data table, for example, in memory 408, and utilize this formant data to create a suitable secondary signal. Alternatively, the user device my extract information from the user's voice to determine the frequency ranges of the formants in the user's voice. The user device can then create a secondary signal that filters the user's voice based on the determined frequency ranges. Furthermore, a combination of these two methods may be used in which the user device extracts information from the user's voice, and then utilizes the extracted information to choose a particular set of pre-existing formant data from the data table. The chosen formant data may then be utilized to create a suitable secondary signal.

Another embodiment of formant cancellation could split the formant domain into a number of independently processed channels, and apply gains or losses to distort the formant's information. For example, a three-band formant processing system may process an audio signal that contains bands existing in 500 to 1,000 Hertz, 1,000 to 2,000 Hertz, and 2,000 to 3,000 Hertz. Gains and/or losses can then be applied to each of the three frequency bands. This processed signal can then be used as the signal to drive the “antisound” projection. Alternatively, rather than being used to drive the conventional, 180° out of phase “antisound” projection, the processed signal could be used in conjunction with other algorithms for synthesizing a desired antisound signal.

Similar to system 700, process 800 can begin at Point A, which coincides with Point A shown in FIG. 6 of process 600. Since process 800 can end at Point B, which likewise coincides with Point B shown in FIG. 6 of process 600, it should be noted that the entirety of process 800 can be contained within step 612 of FIG. 6. In initial step 802 of process 800, the user device can access the buffered audio signal for processing. The user device may have acquired this audio signal from the user in step 608 and then buffered this audio signal in step 610 of process 600, as shown in FIG. 6.

In step 804 of process 800, the user device can process the audio signal to create a secondary signal which can be used for canceling or altering formants. Any suitable method for achieving the formant alterations, such as those described above, can be used for generating this secondary signal. Additionally, if a method is used that does not require knowledge of the user's audio signal, for example, utilizing pre-existing formant data to create a secondary signal, then step 802 could alternatively be an optional step in process 800. When the secondary signal is output in step 806 of process 800, the secondary signal can interfere with and alter the formants of the user's voice. By altering the formants of the user's voice, the user's voice may become unintelligible to third parties in the nearby vicinity.

The processes discussed above are intended to be illustrative and not limiting. Persons skilled in the art will appreciate that steps of the processes discussed herein can be omitted, modified, combined, and/or rearranged, and any additional steps can be performed without departing from the scope of the invention.

In addition to sound cancellation methods which alter the audio signal that the third party hears, the user device can additionally employ preventative feedback. Sometimes a user may speak louder than is necessary. Therefore, the user has the ability to lower his or her voice while still enabling the user device to acquire a loud enough voice signal. One example for this scenario can occur when the user is in the presence of loud ambient noise and thus may have the tendency to unnecessarily raise his or her voice to overcome the ambient noise. However, although this is one example scenario, preventative feedback can be used in any scenario in which the user is speaking louder than necessary or in any scenario in which it may be beneficial to inform the user of his or her voice level.

Further to the discussion above, preventative feedback is related to a method for informing the user of when her speech is louder than necessary. In other embodiments, preventative feedback can inform the user of her voice level, whether this level is too low, too high, or adequate. In this manner, the user is informed of his level of speech and can adjust her voice accordingly. This enables, or even trains, a user to speak at a lower level which is less likely to be bothersome to third party members and can additionally assist in providing the user with more privacy. Alternatively, if a user is speaking too quietly, this method can enable, or even train, the user to speak more loudly. Furthermore, preventative feedback can be used with any combination of the mechanical dampening and sound cancellation systems described above or any other such systems.

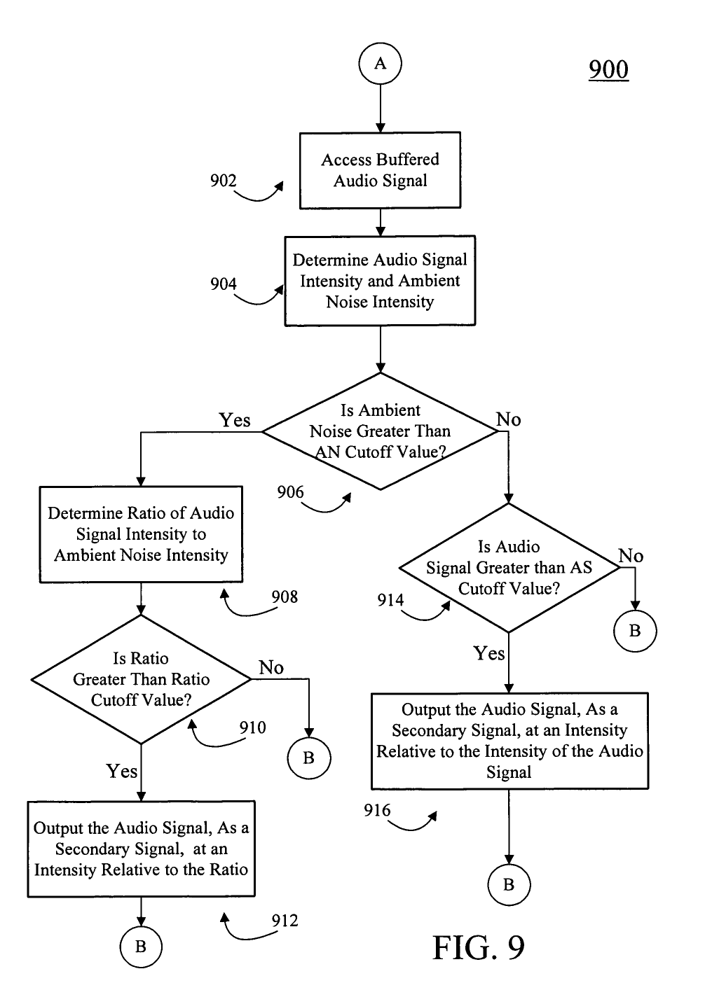

FIG. 9 shows a flowchart of one embodiment of preventative feedback referred to as side-tone awareness. In this system, the user's own voice is played in real time from the user device, at an intensity relative to the user's voice, as a secondary audio signal. This can result in the user hearing his own voice at an elevated volume. In this manner, if the user is speaking too loudly, he can more easily hear his voice. This can cause him to realize that he is speaking too loudly. As a result of the side-tone awareness, the user can then lower his volume of speech.

Similar to the previously mentioned systems, process 900 can begin at Point A, which coincides with Point A shown in FIG. 6 of process 600. Since process 900 can end at Point B, which likewise coincides with Point B shown in FIG. 6 of process 600, it should be noted that the entirety of process 900 can be contained within step 612 of FIG. 6. In initial step 902 of process 900, the user device can access the buffered audio signal for processing. The user device may have acquired this audio signal from the user in step 608 and then stored this audio signal in step 610 of process 600, as shown in FIG. 6.

Process 900 then proceeds to step 904 to determine the intensity of the user's audio signal (the volume of the user's voice) and the intensity of the ambient noise. For example, the intensity could be determined in decibels (dB). The intensity of the audio signal and the intensity of the ambient noise are compared to determine the volume at which to generate the secondary signal. However, step 906 can first determine if the ambient noise is greater than a calibrated ambient noise (AN) Cutoff Value. The reasons for comparing the ambient noise to an AN Cutoff Value will be described in more detail in the descriptions below.

In response to the ambient noise intensity being greater than the calibrated AN Cutoff Value, the user device determines the ratio of the audio signal intensity to the ambient noise intensity in step 908. In step 910, this determined ratio is compared to a Ratio Cutoff Value; the Ratio Cutoff Value can be used to determine if the user is speaking too loudly. For example, if the ambient noise is at a high volume, then the user can likewise raise his voice without the ratio of the audio signal intensity to the ambient noise intensity surpassing the Ratio Cutoff Value. This result indicates that the user is not speaking too loudly. However, if there is not a substantial amount of ambient noise present, the user can surpass the Ratio Cutoff Value by only slightly raising his voice, which would indicate that the user's voice is too loud in that situation. In this manner, process 900 can be used to determine if the user is speaking too loudly.

In response to the ratio of the audio signal intensity to the ambient noise intensity being less then the Ratio Cutoff Value, the process ends at Point B; the user device is not receiving an audio signal which is too loud (i.e., the user is not speaking too loudly, etc.) and it is not necessary to provide side-tone awareness. However, if the ratio is greater than the Ratio Cutoff Value, then side-tone awareness can be performed and the process proceeds to step 912. In step 912, the user device plays the secondary signal at an intensity which is relative to the ratio.

The relative intensity at which the user device plays the secondary signal can be automatically calibrated by the system or calibrated by the user. For instance, it may be desirable to generate the secondary signal at an intensity which is less than, equal to, or greater than the ratio multiplied by the user's audio signal. As an illustrative example, if the user is speaking three times as loudly as the ambient noise, then the ratio will be equal to three. The system or the user can then calibrate the secondary signal's intensity to be three times greater than the user's voice. Alternatively, the system or the user can calibrate the secondary signal to be linearly less (or linearly greater) than three times than the user's voice. For example, the system or user can calibrate the secondary signal's intensity to be half as much (or twice as much) as three times the user's voice.

Alternatively, the secondary signal can be calibrated to be nonlinearly relative to the ratio. For example, the secondary signal can be exponentially relative to the ratio in order to quickly provide additional, louder side-tone awareness to the user as the user's voice becomes louder. Alternatively, in another embodiment the secondary signal can be logarithmic in relation to the ratio or cease increasing in intensity after a certain inflection point. This can help prevent the user from being annoyed or can prevent the user device from being damaged by a secondary signal which is excessively loud. Lastly, as another embodiment, the secondary signal can always be generated at the same volume—regardless of the value of the ratio—as long as the ratio is greater than the Ratio Cutoff Value.

In the event that the ambient noise is too low in intensity, then the user device can proceed to step 914 instead of step 908. As an illustrative example of why step 914 can be performed, in the extreme case where no ambient noise is present, the user's voice will always be infinitely greater then the ambient noise in intensity. Thus, if steps 908, 910, and 912 were followed, the ratio of the audio signal intensity to the ambient noise intensity would likewise be infinite (in the limit as the ambient noise intensity goes to zero). This can result in a secondary signal with an infinite intensity that could potentially be damaging to the user device and bothersome, or even harmful, to the user. Therefore, step 906 can first determine if the ambient noise is greater than a calibrated AN Cutoff Value. In response to the ambient noise being less than the AN Cutoff Value, the secondary signal can be generated based on the intensity of the user's voice rather than based on the ratio of the voice intensity to the ambient noise intensity.

In step 914, the user device determines if the user's voice is greater than an audio signal (AS) Cutoff Value. If the audio signal intensity is less then the AS Cutoff Value, the process ends at Point B; the user device is not receiving an audio signal which is too loud (i.e., the user is not speaking too loudly, etc.) and it is not necessary to provide side-tone awareness. However, if the audio signal intensity is greater than the AS Cutoff Value, then the process proceeds to step 916 and the user device performs side-tone awareness. In step 916, the user device outputs the secondary signal at an intensity which is relative to the user's voice. Once again, similar to step 912, the relative intensity at which the secondary signal is generated can be automatically calibrated by the system or can be calibrated by the user.

Furthermore, system 900 can include control settings which allow the user to manipulate the system. In one embodiment, there can be control settings to determine if the side-tone awareness process is activated or not activated. In another embodiment, there can be controls to set certain criteria to determine when system 900 is active. These criteria can include, for example, ambient noise level, time of day, whether a system according to system 200 or 300 is in use, etc. As yet another embodiment, the user controls can set the value of the AN Cutoff Value, AS Cutoff Value, Ratio Cutoff Value, or the relative intensity at which the secondary signal is generated.

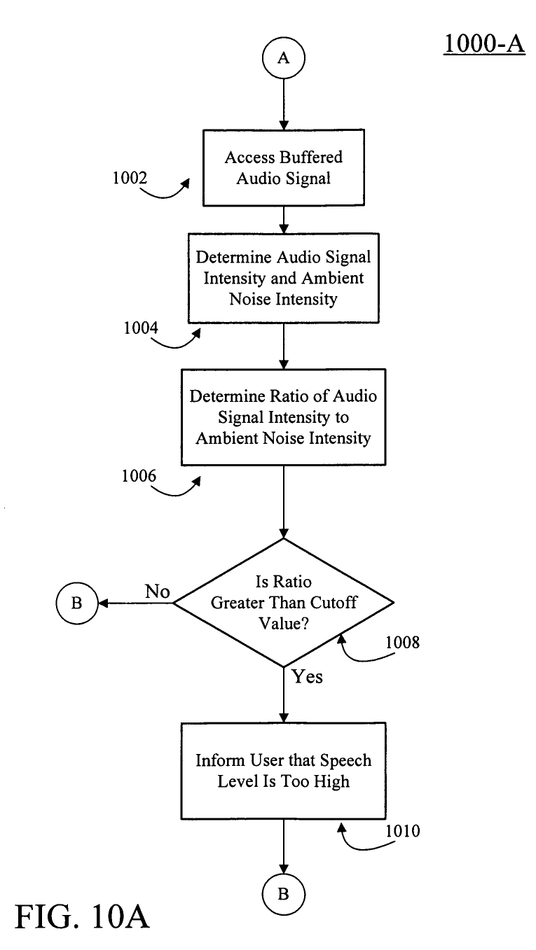

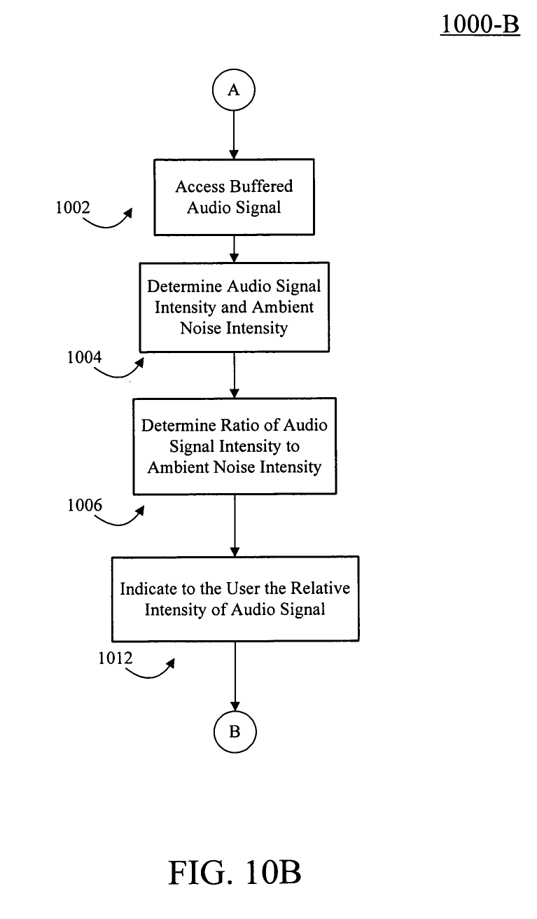

Other embodiments of preventative feedback are illustrated in FIGS. 10A and 10B. Similar to systems 700-900, the entirety of systems 1000-A and 1000-B can be contained within step 612 of FIG. 6. Additionally, similar to system 900, processes 1000-A and 1000-B can begin by accessing the stored audio signal in step 1002 and then determining the audio signal intensity and ambient noise intensity in step 1004. Steps 1002-1004 are performed in the same manner as steps 902-904 of FIG. 9. Both processes can then proceed to step 1006 and determine the ratio of the audio signal intensity to the ambient noise intensity. Step 1006 is performed in the same manner as step 908 of FIG. 9. After step 1006, processes 1000-A and 1000-B cease following the same steps, and each process can carry out a different function.

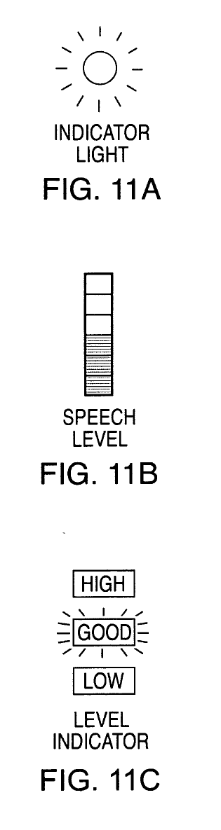

System 1000-A can be utilized to inform the user if his voice level is too high. This is accomplished by determining in step 1008 if the ratio of the audio signal intensity to the ambient noise intensity is greater than a calibrated Cutoff Value. If the ratio is less then the Cutoff Value, the process ends at Point B; the user device is not receiving an audio signal which is too loud (i.e., the user is not speaking too loudly, etc.) and there is no need to send a notification to the user. However, if the ratio is greater than the Cutoff Value, then in step 1010 the user device can inform the user that his voice is too loud. The user device can relay this information to the user in several ways. In one embodiment, as illustrated by FIG. 11A, an indicator light is activated when the ratio is greater than the Cutoff Value. In another embodiment, a certain tone can be emitted to inform the user that he is speaking too loudly. In yet another embodiment, the user device can vibrate when the ratio is above the Cutoff Value. Furthermore, any combination of the above-stated embodiments can be utilized.

System 1000-B can progress to step 1012 after step 1006. In step 1012, the user device can indicate to the user the relative intensity of his voice as compared to the ambient noise. For example, in one embodiment illustrated by FIG. 11B, the user device can contain a series of light emitting or actable bars to indicate the relative intensity of the user's voice. More bars can become activated as the ratio between the user's voice intensity and the ambient noise intensity increases. Alternatively, as illustrated by FIG. 11C, the user device can indicate to the user if his level of speech is too low, adequate, or too high. In yet another embodiment, the user device can utilize a series of tones to indicate the relative intensity of the audio signal. For example, the user device can emit a higher toned pitch if the ratio is above the cutoff value and a lower toned pitch if the ratio is below the cutoff value. In another embodiment, the user device can vibrate at different intensities to inform the user of the relative intensity of the audio signal (i.e., the relative intensity of the user's voice as compared to the ambient noise).

Furthermore, similar to process 900, processes 1000-A and 1000-B can include control settings to allow the user to manipulate the system. In one embodiment, the control settings can be used to determine if process 1000-A, process 1000-B, or neither process is activated. In yet another embodiment, there can be control settings to set which embodiment of processes 1000-A and/or 1000-B is activated. For instance, a system according to FIG. 11A, FIG. 11B, FIG. 11C, or a system consisting of tones, or a system consisting of haptics, or any combination of the above can be utilized. In another embodiment, the controls can set certain criteria to determine when process 1000-A and/or process 1000-B is active. These criteria can include, for example, ambient noise level, time of day, if a system according to device 200 or 300 is in use, etc. As yet another embodiment, the controls can be used to determine the ratio's Cutoff Value or the calibration for portraying the relative intensity of the user's voice to the user.

The processes discussed above are intended to be illustrative and not limiting. Persons skilled in the art will appreciate that steps of the processes discussed herein can be omitted, modified, combined, and/or rearranged, and any additional steps can be performed without departing from the scope of the invention.

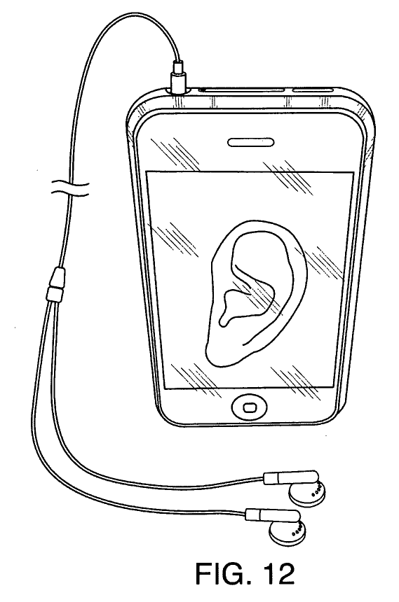

As yet another embodiment for altering speech during cellular phone use, the user device can utilize a “visual ear”, as illustrated by FIG. 12. In this embodiment, an image of an ear can be present on the user device to portray to the user the illusion that she is speaking into an ear. In this manner, the user can be encouraged to refrain from speaking loudly and may have the tendency to lower her voice.

In yet another embodiment, the user device can be equipped with a more sensitive microphone or a directional microphone which can more effectively acquire the user's audio signal (i.e., voice). This can enable the user to speak in a lower voice while still providing an adequate volume of speech for the user device. If a user believes that the user device will effectively hear his voice without the user needing to raise his voice, the user may adjust accordingly and refrain from speaking loudly.

As yet another embodiment, a throat microphone (or other special transducer for the speech signal) can be used, which once again can allow the user to speak in a lower voice while still providing a loud enough voice signal to the user device.

The above described embodiments of the present invention are presented for purposes of illustration and not of limitation, and the present invention is limited only by the claims which follow.

What is claimed is:

1. A method for altering a user's voice during communications with a second party, comprising:
acquiring a spoken audio signal from the user;
processing the user's spoken audio signal to create a secondary audio signal; and
projecting the secondary audio signal in a manner to allow an undesired party to simultaneously hear the user's spoken audio signal and the secondary audio signal.

2. The method of claim 1, wherein processing comprises:
producing an antisound signal that is, at least in part, opposite with respect to the user's spoken audio signal.

3. The method of claim 1, wherein processing comprises:
producing a secondary signal that, when combined with the user's spoken audio signal, will alter the formants in the user's spoken audio signal.

4. The method of claim 1, wherein projecting comprises:
producing the secondary audio signal in a manner that interferes with the user's spoken audio signal to lower the intensity of the user's spoken audio signal.

5. The method of claim 1, wherein projecting comprises:
producing the secondary audio signal in a manner that interferes with the user's spoken audio signal so much that it renders the user's audio spoken signal unintelligible.

6. The method of claim 1 further comprising:
prohibiting the secondary audio signal from being projected to the second party.

7. The method of claim 1 further comprising:
determining if mechanical dampening is present.

8. The method of claim 7 further comprising:
altering the secondary audio signal to account for any mechanical dampening present.

9. A system for altering a user's voice, comprising:
a user communication device;
a shield, electrically coupled to the communication device, that:
acquires a spoken audio signal from the user;
processes the user's spoken audio signal to create a secondary audio signal; and
projects the secondary audio signal in a manner to allow an undesired party to simultaneously hear the user's spoken audio signal and the secondary audio signal.

10. The system of claim 9, wherein the secondary audio signal is an antisound signal with respect to the user's audio signal.

11. The system of claim 9, wherein the secondary audio signal interferes with the user's audio signal to lower the intensity of the user's audio signal.

12. The system of claim 9, wherein the secondary audio signal interferes with the user's audio signal to render the user's audio signal unintelligible.

13. The system of claim 9, wherein the shield projects the secondary audio signal in a manner to not allow a second party to hear the secondary audio signal, wherein the user is communicating with the second party.

14. The system of claim 9, wherein the shield determines if mechanical dampening is present.

15. The system of claim 14, wherein the shield alters the secondary audio signal to account for any mechanical dampening present.

16. A method of performing preventative feedback, comprising:
receiving a spoken audio signal from a user;
determining the intensity of the user's spoken audio signal;
determining the intensity of ambient noise;
determining the ratio of the intensity of the user's spoken audio signal to the intensity of the ambient noise; and
creating a secondary audio signal, based on the user's spoken audio signal, which is generated at an intensity relative to the ratio.

17. The method of claim 16 further comprising:
determining a ratio cutoff value; and
projecting the secondary audio signal in response to the ratio being greater than the ratio cutoff value.

18. The method of claim 16 further comprising:
determining an ambient noise cutoff value; and
projecting the secondary audio signal in response to the ambient noise intensity being greater in value than the ambient noise cutoff value.

19. A method of performing preventative feedback, comprising:
receiving a spoken audio signal from a user;
determining the intensity of the user's spoken audio signal;
determining the intensity of ambient noise, wherein the ambient noise is in audible range of the user;
calculating an ambient noise cutoff value; and
creating a secondary audio signal, based on the user's spoken audio signal, at an intensity relative to the intensity of the user's audio signal and in response to the ambient noise intensity being less in value than the ambient noise cutoff value.

20. The method of claim 19 further comprising:
determining an audio signal cutoff value; and
projecting the secondary audio signal in response to the user's spoken audio signal intensity being greater in value than the audio signal cutoff value.

21. A method of performing preventative feedback, comprising:
receiving a spoken audio signal from a user;
determining the intensity of the user's spoken audio signal;
calculating the intensity of ambient noise;
determining the ratio of the intensity of the user's spoken audio signal to the intensity of the ambient noise; and
generating an alert for displaying to the user in response to the ratio.

22. The method of claim 21, wherein the alert indicates to the user that the ratio is greater than a predetermined cutoff value.

23. The method of claim 21, wherein the alert indicates the value of the ratio to the user.

24. The method of claim 21, wherein the alert is a visual cue.

25. The method of claim 21, wherein the alert is an audio cue.

26. The method of claim 21, wherein the alert is a haptical cue.
